(19) United States
(12) Patent Application Publication
(10) Pub. No.: US 2004/0107561 A1
(43) Pub. Date: Jun. 10, 2004

(54) Electrostatically shielded radio frequency plasma apparatus and method of manufacturing

(75) Inventors: Steven T. Fink, Mesa, AZ (US); Robert G. Hostetler, Maricopa, AZ (US)

Correspondence Address: PILLSBURY WINTHROP, LLP, P.O. BOX 10500, MCLEAN, VA, 22102, US

(73) Assignee: Tokyo Electron Limited, Tokyo (JP)

(21) Appl. No.: 10/670,742

(22) Filed: Sep. 26, 2003

Related U.S. Application Data
(60) Provisional application No. 60/414,418, filed on Sep. 30, 2002.

(51) Int. Cl. B01J 19/08

(52) U.S. Cl. 29/592.1; 422/186.29

(57) ABSTRACT

An electrostatically shielded radio frequency (ESRF) plasma apparatus includes a process chamber which encloses a plasma area and a resonator assembly which surrounds the plasma area and includes a coil. The ESRF plasma apparatus also includes a clamping plate which secures the resonator assembly to at least the process chamber. In this manner, the geometry of the resonator chamber can be altered while maintaining the plasma area in an evacuated state. Additionally, an electrostatic shield may be provided and the ESRF plasma apparatus may also be configured such that the electrostatic shield can be replaced while maintaining the plasma area in an evacuated state. Additionally, the resonator assembly may be constructed of sheet metal and may be assembled using standard flanges. Additionally, seals, which are used to seal the plasma area and the resonator assembly, are standard seals.

This non-provisional application claims the benefit of Provisional Application No. 60/414,418, filed Sep. 30, 2002, the contents of which are incorporated in their entirety herewith.

### BACKGROUND OF THE INVENTION

1. Field of Invention

The present invention relates to plasma processing systems. More particularly, the present invention relates to an electrostatically shielded radio frequency plasma apparatus and a method for manufacturing the same.

2. Description of Related Art

Typically, plasma is a collection of species, some of which are gaseous and some of which are charged. Plasmas are useful in certain processing systems for a wide variety of applications. For example, plasma processing systems are of considerable use in material processing and in the manufacture and processing of semiconductors, integrated circuits, displays and other electronic devices, both for etching and layer deposition on substrates, such as, for example, semiconductor wafers.

One type of plasma processing system is the inductively coupled plasma (ICP) system and a particular type of ICP system is an electrostatically shielded radio frequency (ESRF) plasma apparatus. The basic components of an ESRF plasma apparatus may typically include a chamber in which a plasma is formed, a chuck for supporting a wafer, and a plasma source including a resonator chamber which typically houses a coil which surrounds the plasma chamber. ESRF plasma sources feature inductive coupling and accordingly, the radio frequency (RF) power produces mainly plasma density and induces little voltage on the plasma.

The geometry of the ESRF plasma source depends on various processing parameters. More specifically, the geometry of the ESRF plasma source and its shielding may need to be altered depending on various process parameters. Generally, to vary the geometry of the plasma source or to simply replace a component, the plasma source is dismantled and the parts are replaced. Additionally, since the plasma chamber is exposed to the atmosphere when the plasma source is dismantled, a lengthy pump down of the system is required before any processing can occur in the plasma chamber.

### SUMMARY OF THE INVENTION

The present invention provides a novel electrostatically shielded radio frequency (ESRF) plasma apparatus and a method for manufacturing the same.

The ESRF plasma apparatus includes a process chamber which encloses a plasma area and a resonator assembly which surrounds the plasma area and includes a coil. The ESRF plasma apparatus also includes a clamp which secures the resonator assembly to at least the process chamber. In this manner, a geometry of the resonator chamber can be altered while maintaining the plasma area in an evacuated state. Additionally, an electrostatic shield may be provided and the ESRF plasma apparatus may also be configured such that the electrostatic shield can be replaced while maintaining the plasma area in an evacuated state.

Additionally, the resonator assembly may be constructed of sheet metal and may be assembled using flanges. Additionally, seals, which are used to seal the plasma area and the resonator assembly, are standard seals.

### BRIEF DESCRIPTION OF THE DRAWINGS

FIG. 1 is a cross-sectional view of an embodiment of an electrostatically shielded radio frequency plasma apparatus in accordance with the principles of the present invention;

FIG. 2 is a partial cross-sectional view of the source for an electrostatically shielded radio frequency plasma apparatus as shown in FIG. 1 in accordance with the principles of the present invention;

FIG. 3 is a partial cross-sectional view of the resonator assembly for an electrostatically shielded radio frequency plasma source as shown in FIG. 2 in accordance with the principles of the present invention;

FIG. 4 is a partial cross-sectional view of another embodiment of a resonator chamber for an electrostatically shielded radio frequency plasma apparatus in accordance with the principles of the present invention; and

FIG. 5 is a partial cross-sectional view of another embodiment of a resonator chamber for an electrostatically shielded radio frequency plasma apparatus in accordance with the principles of the present invention.

### DETAILED DESCRIPTION OF EMBODIMENTS OF THE INVENTION

Embodiments of the present invention will be described in more detail below with like reference numerals indicating like features.

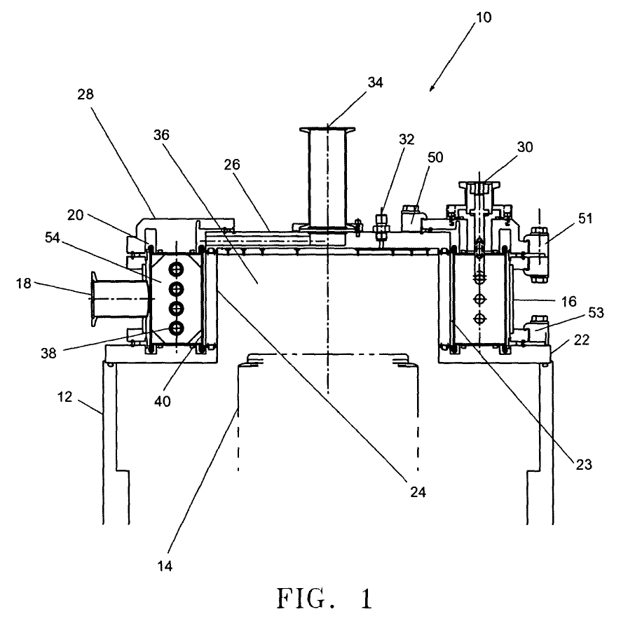

FIG. 1 is a cross-sectional view of an embodiment of an electrostatically shielded radio frequency (ESRF) plasma processing apparatus including an ESRF plasma source 10 in accordance with the principles of the present invention. A process chamber 12 and a chuck assembly 14 are located below the ESRF plasma source 10. For example, ESRF source 10 can be coupled to process chamber 12 using hinges and/or clamps. A wafer to be processed is generally placed on the chuck assembly 14. The ESRF plasma source 10 includes a housing assembly 16 and a plasma area 36 where the plasma is essentially located during operation. The plasma area 36 is generally contained by a dielectric chamber wall or process tube 24. Additionally, the ESRF plasma source 10 includes a helical coil 38 located within a resonator assembly 20. In normal operation, helical coil 38 is supported within resonator assembly 20 by dielectric material 54. Alternately, resonator assembly 20 does not comprise dielectric material 54. The resonator assembly 20 may be fluid cooled in which case the fluid may enter the cooling chamber 23 via a coolant in port 18 and a coolant out port 34. A process chamber adapter plate 22 can be coupled to process chamber 12, process tube 24, and housing assembly 16. For example, a plurality of single claw clamps 53 can be used to couple housing assembly 16 to process chamber adapter plate 22.

The ESRF plasma source 10 may also include an inject assembly 26 located above the dielectric chamber wall or process tube 24. The inject assembly 26 may form the top portion of the plasma area 36 and is typically constructed of a metallic plate, however any suitable material may be used. The inject assembly 26 is generally used to distribute gas through a gas inlet 32 which is used in forming a plasma in the plasma area 36. Additionally, the inject assembly 26 may also be used to distribute the cooling fluid for cooling the resonator assembly 20 and the inject assembly itself. Further, an upper clamping plate 28 may be utilized to secure resonator assembly 20, the inject assembly 26 and the process tube 24 to the housing assembly 16. For example, a plurality of single claw clamps 50 can be used to couple upper clamping plate 28 to inject assembly 26, and a plurality of double claw clamps 51 can be used to couple upper clamping plate 28 to housing assembly 16.

A fast match assembly interface 30 may also be provided on top of the upper clamping plate 28 to supply radio frequency (RF) energy to coil 38 and provide appropriate insulating and RF grounding.

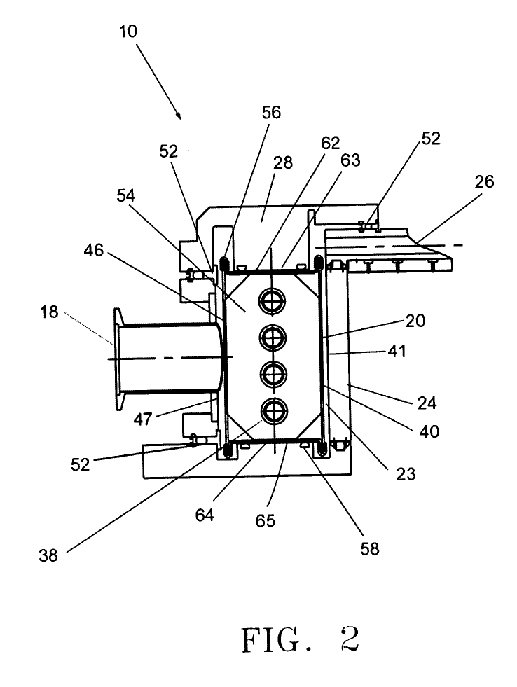

FIG. 2 is an enlarged partial cross-sectional view of an embodiment of plasma source 10 shown in FIG. 1 in accordance with the principles of the present invention. As shown, the resonator assembly 20 is located within the cooling chamber 23. For example, cooling chamber 23 can comprise a top wall 63, a bottom wall 65, and side walls 41 and 47. The resonator assembly 20 can include an outer wall 46, a lower wall 64, a upper wall 62 The electrostatic shield 40 is the inner wall of the resonant assembly 20. The coil 38, inject assembly 26, process tube 24 and coolant in port 18 are similar to those described above, with respect to FIG. 1. At least one end of helical coil 38 is securely attached to the upper wall 62 so as to make an adequate mechanical and electrical ground connection. Although not shown in FIG. 2, a hole can be made in the upper wall 62 for connecting the helical coil 38 to the fast match assembly 30 (FIG. 1) if necessary.

Further, centering ring assemblies 52 are provided to seal the cooling fluid plenums. Alternately, o-rings can be used. The centering ring assemblies 52 do not require that flanges or grooves are machined into the adjoining parts. Rather these seals are standard seals that are easily replaced and relatively inexpensive, for example, an ISO (International Standards Organization) type of centering ring assembly can be usedl. Grounding features 58 can be utilized to more adequately ground the resonator structure. The grounding features can also be used to take up tolerances in the plasma source assembly as it is fabricated.

With the above configuration, it is possible to replace and/or change the properties/geometry of the resonator assembly 20 or change the electrostatic shield 40 while maintaining an evacuated state within the plasma area 36. The inject assembly 26 is provided as a top portion of the plasma area 36 and the upper clamping plate 28 initially secures and seals the plasma area 36. Once evacuated, the vacuum in the plasma area can be used to hold the inject assembly 26 in place, and the plasma area can be maintained in the evacuated state without the assistance of the upper clamping plate 28. Accordingly, the upper clamping plate 28 can be removed to allow the replacement of the resonator assembly 20 and the electrostatic shield 40 while maintaining the evacuated state of the plasma area 36.

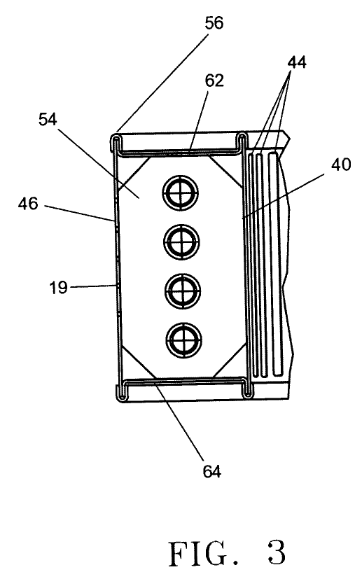

FIG. 3 is an enlarged partial cross-sectional view of the resonator assembly 20 for an ESRF plasma source 10 as shown in FIG. 2 in accordance with the principles of the present invention. As can be more clearly seen, the upper wall 62 and the lower wall 64 include a flange which mates with its respective side walls and an assembly clip 56 may be utilized to couple the walls to one another. The assembly clip 56 may be a plurality of clips running across the length of the mating surface or a continuous clip may be used to couple the upper wall 62 and lower wall 64 to the outer wall 46 and the inner wall 40. Additionally, the resonator walls can be fabricated from sheet metal. For example, the outer wall 46 can be a single piece of sheet metal which is rolled into a cylindrical shape and cut to the appropriate diameter.

The helical coil 38 is generally constructed of a metal tube which has a particular diameter and wall thickness. As would be readily understood by a person skilled in the art, the properties of the helical coil 38 vary on at least the processing parameters. As described above, the helical coil 38 may be securely attached to an upper wall 62 of the resonator assembly 20, and the helical coil 38 can terminate in a blunt end. Again, as would be understood by a person skilled in the art, the length of the coil would be determined by at least the coil tuning requirements. The inner wall 40 acts as an electrostatic shield for the resonator assembly 20 and is also typically metallic in nature. The inner wall 40 generally has numerous slots 44 which are arranged with a specific geometry depending on at least one of the process parameters and the electrostatic shielding requirements. In normal operation, coolant holes 19 on an outer wall 46 of the resonator assembly 20 allow coolant fluid in and the slots 44 in the electrostatic shield 40 allow the cooling fluid to exit the resonator assembly 20. Alternately, resonator assembly 20 does not comprise coolant holes 19.

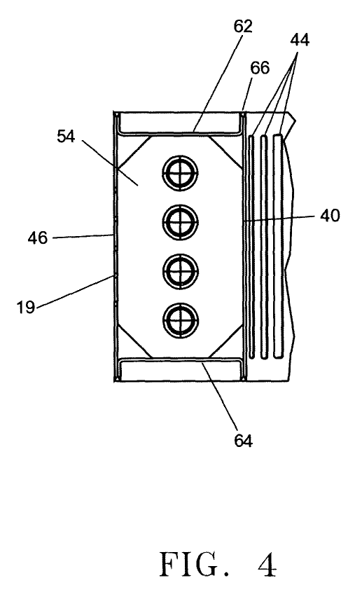

FIG. 4 is a partial cross-sectional view of another embodiment of a resonator assembly 20 for an ESRF plasma source 10 in accordance with the principles of the present invention. In this embodiment, the resonator assembly 20 is similar to those previously described with respect to FIGS. 2 and 3. The upper wall 62 and lower wall 64, each include flanges to mate with the respective side walls however, rather than using assembly clips 56, the individual pieces are soldered or brazed as indicated at 66. Again, the brazing of the materials need not be continuous.

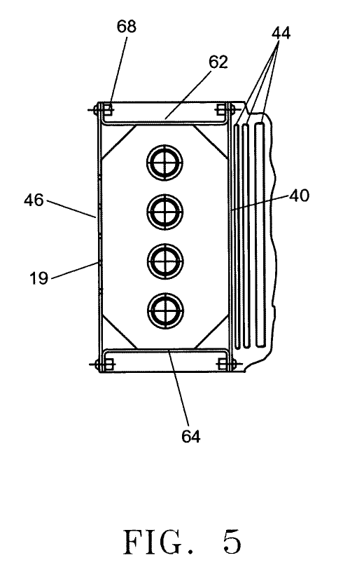

FIG. 5 is a partial cross-sectional view of another embodiment of a resonator assembly 20 for an ESRF plasma source 10 in accordance with the principles of the present invention. In this embodiment, the walls of the resonator assembly 20, which may be constructed of sheet metal, are coupled together utilizing a rivet 68 rather than an assembly clip 56 or a brazed joint 66.

With the embodiments of FIGS. 4 and 5, as with the embodiment of FIGS. 1 through 3, it is possible to replace and/or change the properties/geometry of the resonator assembly 20 and/or ESRF source 10 while maintaining an evacuated state within the plasma area 36. The inject assembly 26 is provided as a top portion of the plasma area 36 and the upper clamping plate 28 initially secures and seals the plasma area 36. Once evacuated, the vacuum in the plasma area can hold the inject assembly 26 in place and, the evacuated state of the plasma area 36 can be maintained without the assistance of the upper clamping plate 28. Accordingly, the upper clamping plate 28 can be removed to allow the replacement of the resonator assembly 20 and the housing assembly 16 while maintaining the evacuated state of the plasma area 36.

As would be readily understood by a person skilled in the art, any type of construction similar to the embodiments described above would aid in more easily disassembling an ESRF plasma source 10 and reassembling the same without breaking the process seals and thus not having to perform a pump down of the system prior to beginning processing. Also, additional coupling methods may be utilized to assemble the resonator assembly 20. For example, screws or the like may be utilized or a combination of these methods may be utilized for various reasons, including additional strength at the mating surfaces.

The foregoing presentation of the described embodiments is provided to enable any person skilled in the art to utilize the present invention. Various modifications to these embodiments are possible and the generic principle of an ESRF plasma apparatus with a resonator assembly and electrostatic shield that can be more easily changed and reinstalled into the plasma apparatus without breaking the process vacuum presented herein may be applied to other embodiments as well. Thus, the present invention is not intended to be limited to the embodiments shown above, but rather to be accorded the widest scope consistent with the principles and novelty of the features disclosed in any fashion herein.

What is claimed is:

1. An electrostatically shielded radio frequency (ESRF) plasma apparatus comprising:
a process chamber enclosing a plasma area;
a resonator assembly surrounding said plasma area, said resonator assembly comprising a coil provided within said resonator assembly;
a housing assembly coupled to said process chamber and surrounding said resonator assembly; and
a clamping plate coupled to said process chamber and said housing assembly, said clamping plate securing said resonator assembly to at least said process chamber;
wherein at least one of said resonator assembly, said housing assembly, and said clamping plate can be removed while maintaining said plasma area in an evacuated state.

2. The ESRF plasma apparatus as claimed in claim 1, wherein walls of said resonator assembly are constructed of sheet metal.

3. The ESRF plasma apparatus as claimed in claim 2, wherein an upper wall and a lower wall are provided with a mating surface for coupling said upper wall and said lower wall to an outer wall and an inner wall.

4. The ESRF plasma apparatus as claimed in claim 3, wherein said upper wall and said lower wall are coupled to said inner wall and said outer wall with at least one assembly clip.

5. The ESRF plasma apparatus as claimed in claim 1, wherein said housing assembly is coupled to said process chamber using at least one standard ISO (International Standards Organization) centering ring assembly.

6. The ESRF plasma apparatus as claimed in claim 3, wherein said upper wall and said lower wall are coupled to said inner wall and said outer wall by brazing.

7. The ESRF plasma apparatus as claimed in claim 3, wherein said upper wall and said lower wall are coupled to said inner wall and said outer wall with a plurality of rivets.

8. The ESRF plasma apparatus as claimed in claim 1, wherein said housing assembly is coupled to said clamping plate using at least one standard ISO (International Standards Organization) centering ring assembly.

9. The ESRF plasma apparatus as claimed in claim 1, wherein said clamping plate is coupled to said process chamber using at least one standard ISO (International Standards Organization) centering ring assembly.

10. The ESRF plasma apparatus as claimed in claim 1, wherein said resonator assembly comprises an inner wall configured as an electrostatic shield with at least one slot.

11. The ESRF plasma apparatus as claimed in claim 1, further comprising a cooling chamber in which said resonator assembly is fluidly cooled.

12. An electrostatically shielded radio frequency (ESRF) plasma source comprising:
a process chamber adapter plate configured to mount said ESRF source to a process chamber;
a process tube coupled to said plate, said process tube enclosing a plasma area;
an inject assembly coupled to said process tube;
a resonator assembly surrounding said process tube, said resonator assembly comprising a coil provided within said resonator assembly;
a housing assembly coupled to said process chamber adapter plate and surrounding said resonator assembly; and
a clamping plate coupled to said inject assembly and said housing assembly, said clamping plate securing said resonator assembly to said process chamber adapter plate;
wherein at least one of said resonator assembly, said housing assembly, and said clamping plate can be removed while maintaining said plasma area in an evacuated state.

13. The ESRF plasma source as claimed in claim 12, wherein walls of said resonator assembly are constructed of sheet metal.

14. The ESRF plasma source as claimed in claim 13, said resonator assembly comprising an upper wall, a lower wall, an outer wall and an inner wall, wherein said upper wall and said lower wall are provided with a mating surface for coupling said upper wall and said lower wall to said outer wall and said inner wall.

15. The ESRF plasma source as claimed in claim 14, wherein said upper wall and said lower wall are coupled to said inner wall and said outer wall with at least one assembly clip.

16. The ESRF plasma source as claimed in claim 12, wherein said housing assembly is coupled to said process chamber adapter plate using at least one standard ISO (International Standards Organization) centering ring assembly.

17. The ESRF plasma apparatus as claimed in claim 12, wherein said clamping plate is coupled to said inject assembly using at least one standard ISO (International Standards Organization) centering ring assembly.

18. The ESRF plasma source as claimed in claim 14, wherein said upper wall and said lower wall are coupled to said inner wall and said outer wall by brazing.

19. The ESRF plasma source as claimed in claim 14, wherein said upper wall and said lower wall are coupled to said inner wall and said outer wall with a plurality of rivets.

20. The ESRF plasma source as claimed in claim 12, wherein said housing assembly is coupled to said clamping plate using at least one standard ISO (International Standards Organization) centering ring assembly.

21. The ESRF plasma source as claimed in claim 12, wherein the geometry of said resonator assembly can be altered while maintaining said plasma area in an evacuated state.

22. The ESRF plasma source as claimed in claim 19, wherein said resonator assembly comprises a cooling chamber in which said resonator assembly is fluidly cooled.

23. A method for manufacturing a resonator assembly for an electrostatically shielded radio frequency (ESRF) plasma source, said method comprising.
constructing an outer portion and an inner portion of said resonator assembly by rolling sheet metal into cylinders with the appropriate diameter and height;
constructing an upper portion and a lower portion of said resonator assembly by fabricating sheet metal into discs with an appropriate outer diameter and inner diameter;
producing at least one flange on said upper portion and said lower portion to mate said upper portion and said lower portion to said inner portion and said outer portion; and
coupling said upper portion and said lower portion to said outer portion and said inner portion.

24. The method for manufacturing a resonator assembly as claimed in claim 23, wherein said coupling is performed with at least one assembly clip.

25. The method for manufacturing a resonator assembly as claimed in claim 23, wherein said coupling is performed with a plurality of rivets.

26. The method for manufacturing a resonator assembly as claimed in claim 23, wherein said coupling is performed by brazing said upper portion and said lower portion to said outer portion and said inner portion.
